(19) United States
(12) Patent Application Publication
(10) Pub. No.: US 2006/0271217 A1
(43) Pub. Date: Nov. 30, 2006

(54) Manufacturing study support device

(75) Inventors: Kaname Suzuki, Kawasaki (JP); Kenji Hasegawa, Kawasaki (JP); Masahiko Yamada, Kawasaki (JP); Koji Yoshioka, Kawasaki (JP); Yoshitaka Muraoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/213,947

(22) Filed: Aug. 30, 2005

(30) Foreign Application Priority Data
May 31, 2005 (JP) 2005-159247

(51) Int. Cl. G06F 19/00

(52) U.S. Cl. 700/97

(57) ABSTRACT

A device to support studies of the positions in which parts necessary for assembly are placed and the positions in which assembly tasks are performed. A manufacturing study support device has a computation portion, a display portion which displays animations, and a storage portion which stores part animation data comprising three-dimensional shapes of parts, part storage positions which are three-dimensional coordinate data of positions at which the parts are stored, and assembly starting positions which are three-dimensional coordinate data of positions from which assembly tasks using the parts are started. The computation portion calculates part supply animation paths, taking the part storage positions as starting points and the assembly starting positions as ending points, and based on the part animation data and part supply animation paths, causes the display portion to display movement of the parts.

### CROSS-REFERENCE TO RELATED APPLICATIONS

This application is based upon and claims the benefit of priority from the prior Japanese Patent Application No. 2005-159247, filed on May 31, 2005, the entire contents of which are incorporated herein by reference.

### BACKGROUND OF THE INVENTION

1. Field of the Invention

The present invention relates to a manufacturing study support device which provides support for evaluation of part storage positions and assembly initiation positions in the manufacture of products through the assembly of parts by workers.

2. Description of the Related Art

With the increasingly fierce cost competition among products in recent years, product cycles have become shorter. And consumer needs continue to grow more diverse. In response to such a market environment, manufacturers must accommodate changes in demand while lowering manufacturing costs.

In order to manufacture products which accommodate changes in demand, there are relatively numerous assembly tasks which rely on human labor that can cope flexibly with changes in model types and production amounts. And, when humans perform assembly, more detailed changes can be accommodated through assembly tasks in which a single individual performs a plurality of processes. In order to manufacture products at low cost while accommodating changes in demand, the required goods must be manufactured with no waste. To this end, in assembly tasks it is necessary that assembly be performed accurately, and that assembly working conditions be satisfactory.

In order to improve assembly working conditions, parts and three-dimensional data for parts are used to perform simulations, and assembly paths are studied. A system to verify whether assembly is possible through simulations generally adopts a method which starts from the state of a product after assembly, based on information relating to parts designed using a three-dimensional CAD system and to part assembly positions, searches for disassembly paths for which interference (contact between parts) does not occur, and taking a disassembly path in which such interference does not occur, reverses the direction of the disassembly path to obtain the assembly path.

FIG. 10 is an example of a system which verifies whether assembly is possible. Here, parts 901, 902, 903 are mounted onto the product 900. At this time, assembly tasks are realized by moving each of the parts from their assembly starting positions to their assembly finishing positions.

In such a system, it is possible to study whether a designed product can actually be assembled or disassembled, without performing actual trials.

The technology described in Japanese Patent Laid-open No. 10-312208 relates to a device to generate assembly paths through simulations.

However, in a system to verify whether such assembly is possible or not, positions in which the parts necessary for assembly are placed, and positions in which assembly tasks are performed, are not studied. Optimization of the storage positions of parts and task positions is, together with optimization of assembly tasks themselves, extremely important to improve task efficiency.

Hence an object of this invention is to provide a device to support studies of the positions in which parts necessary for assembly are placed and of the positions in which assembly tasks are performed.

### SUMMARY OF THE INVENTION

In order to resolve the above issues, a first aspect of the invention is a manufacturing study support device, in which the placement of a plurality of parts is displayed in a virtual space, and assembly tasks are displayed by causing the movement of representations of the plurality of parts, to support studies of the efficiency of assembly tasks, and is characterized in having a computation portion, a display portion which displays animations, and a storage portion which stores part animation data comprising the three-dimensional shapes of parts, part storage positions which are three-dimensional coordinate data for positions at which the parts are stored, and assembly starting positions which are three-dimensional coordinate data of positions at which assembly tasks are started using the parts; and is further characterized in that the computation portion determines part supply animation paths taking the part storage positions as starting points and the assembly starting positions as ending points, and based on the part animation data and part supply animation paths, causes movements of the parts to be displayed by the display portion.

A preferred embodiment of the above first aspect of the invention is characterized in that a part supply animation path is resolved into a first direction, a second direction orthogonal to the first direction, and a third direction orthogonal to the first and second directions.

A still more preferred embodiment of the above first aspect of the invention is characterized in that the order of display of the three directions of the resolved part supply animation path can be edited.

A still more preferred embodiment of the above first aspect of the invention is characterized in that the storage portion further stores part storage vectors, which are three-dimensional direction vectors indicating the orientations of the parts in the part storage positions, and part assembly vectors, which are three-dimensional direction vectors indicating the orientations of the parts in the assembly starting positions; and the computation portion generates, and causes the display portion to display, animations showing the orientation rotation to the part supply animation path based on the part assembly vectors, from part animation data based on the part storage vectors.

A still more preferred embodiment of the above first aspect of the invention is characterized in that the storage portion further stores environment information, comprising three-dimensional coordinate data and three-dimensional shape data for objects existing at positions which may be in the part supply animation paths, and in that, based on the environment information, the computation portion generates part supply animation paths for which there is no interference with the objects.

A still more preferred embodiment of the above first aspect of the invention is characterized in that the storage portion further stores assembly ending positions, which are three-dimensional coordinate data of positions at which assembly tasks using the parts end, and in that the computation portion further causes the display portion to display part assembly paths from the assembly starting positions to the assembly ending positions and next-part movement paths from the assembly ending positions to the part storage positions of parts used in next assembly.

A second aspect of the invention is a manufacturing study support program, which displays the placement of a plurality of parts in a virtual space, and displays assembly tasks by causing the movement of representations of the plurality of parts, to support studies of the efficiency of assembly tasks, and is characterized in causing a computer to execute an information acquisition process of acquiring part storage positions, which are three-dimensional coordinate data of the positions in which parts are stored, and assembly starting positions, which are three-dimensional coordinate data of the positions from which assembly tasks using the parts are started; a path calculation process of calculating part supply animation paths, taking the part storage positions as starting points and the assembly starting positions as ending points; and a display process of displaying the movement of the parts, based on part animation data comprising the three-dimensional shapes of the parts and on the part supply animation paths.

A preferred embodiment of the above second aspect of the invention is characterized in that a part supply animation path is resolved into a first direction, a second direction orthogonal to the first direction, and a third direction orthogonal to the first and second directions.

A still more preferred embodiment of the above second aspect of the invention is characterized in that the order of display of the three directions of the resolved part supply animation path can be edited.

A still more preferred embodiment of the above second aspect of the invention is characterized in that the information acquisition process further acquires part storage vectors, which are three-dimensional direction vectors indicating the orientations of the parts in the part storage positions, and part assembly vectors, which are three-dimensional direction vectors indicating the orientations of the parts in the assembly starting positions; and the display process displays animations showing the orientation rotation to the part supply animation path based on the part assembly vectors, from part animation data based on the part storage vectors.

A still more preferred embodiment of the above second aspect of the invention is characterized in that, based on environment information comprising three-dimensional coordinate data and three-dimensional shape data for objects existing at positions which may be in the part supply animation paths, the path calculation process further calculates the part supply animation paths which do not interfere with the objects.

A still more preferred embodiment of the above second aspect of the invention is characterized in that the information acquisition process further acquires assembly ending positions, which are three-dimensional coordinate data of positions at which assembly tasks using the parts end, in that the path calculation process further calculates part assembly paths from the assembly starting positions to the assembly ending positions and next-part movement paths from the assembly ending positions to the part storage positions of parts used in next assembly, and in that the display process further displays the part assembly paths and next-part movement paths.

A third aspect of the invention is a manufacturing study support method, which displays the placement of a plurality of parts in a virtual space, and displays assembly tasks by causing the movement of the plurality of parts, to support studies of the efficiency of assembly tasks, and is characterized in having an information acquisition process of acquiring part storage positions, which are three-dimensional coordinate data of the positions in which parts are stored, and assembly starting positions, which are three-dimensional coordinate data of the positions from which assembly tasks using the parts are started; a path calculation process of calculating part supply animation paths, taking the part storage positions as starting points and the assembly starting positions as ending points; and a display process of displaying the movement of the parts, based on part animation data comprising the three-dimensional shapes of the parts and on the part supply animation paths.

A preferred embodiment of the above third aspect of the invention is characterized in that a part supply animation path is resolved into a first direction, a second direction orthogonal to the first direction, and a third direction orthogonal to the first and second directions.

A still more preferred embodiment of the above third aspect of the invention is characterized in that the order of display of the three directions of the resolved part supply animation path can be edited.

A still more preferred embodiment of the above third aspect of the invention is characterized in that the information acquisition process further acquires part storage vectors, which are three-dimensional direction vectors indicating the orientations of the parts in the part storage positions, and part assembly vectors, which are three-dimensional direction vectors indicating the orientations of the parts in the assembly starting positions; and the display process displays animations showing the orientation rotation to the part supply animation path based on the part assembly vectors, from part animation data based on the part storage vectors.

A still more preferred embodiment of the above third aspect of the invention is characterized in that, based on environment information comprising three-dimensional coordinate data and three-dimensional shape data for objects existing at positions which may be in the part supply animation paths, the path calculation process further calculates the part supply animation paths which do not interfere with the objects.

A still more preferred embodiment of the above third aspect of the invention is characterized in that the information acquisition process further acquires assembly ending positions, which are three-dimensional coordinate data of positions at which assembly tasks using the parts end, in that the path calculation process further calculates part assembly paths from the assembly starting positions to the assembly ending positions and next-part movement paths from the assembly ending positions to the part storage positions of parts used in next assembly, and in that the display process further displays the part assembly paths and next-part movement paths.

By displaying the supply of parts from part storage positions to assembly starting positions, a manufacturing study support device of this invention can support studies of optimization of part storage positions and assembly starting positions.

### BRIEF DESCRIPTION OF THE DRAWINGS

FIG. 1 shows the configuration of a manufacturing study support device of an aspect of the invention;

FIG. 2 is a flowchart of part supply animation generation in the manufacturing study support device of an aspect of the invention;

FIG. 3 shows resolution into three-dimensional direction components of a part supply animation path;

FIG. 4 is a diagram of a case of resolution into three-dimensional direction components of a part supply animation path, while performing interference checks;

FIG. 5 shows changes in the order of the three-dimensional direction components of a part supply animation path;

FIG. 6 shows rotation of the orientation of a part;

FIG. 7 is an example of a part supply animation, assembly animation, and an animation showing the trajectory to the next-part supply position;

FIG. 8 is an example of the configuration of assembly animation data;

FIG. 9 is an example of a data table generated through input of data;

FIG. 10 is an example of a display by a system which verifies whether assembly is possible; and,

FIG. 11 is an example showing an example of modeling using CAD data for a three-dimensional object.

### DESCRIPTION OF THE PREFERRED EMBODIMENTS

Below, aspects of the invention are explained referring to the drawings. However, the technical scope of the invention is not limited to these aspects, but extends to the inventions described in the scope of claims, and to inventions equivalent thereto.

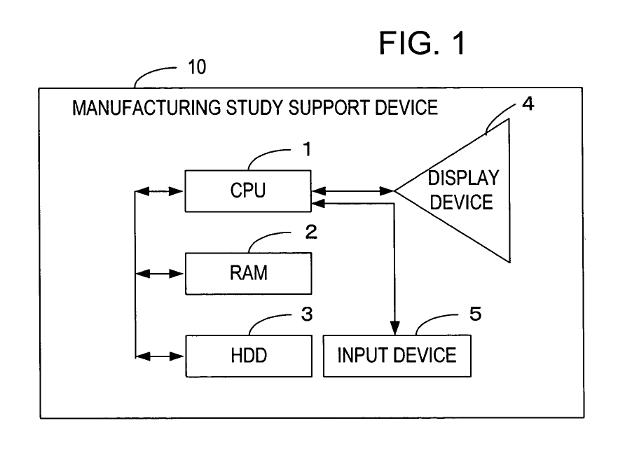

FIG. 1 shows the configuration of a manufacturing study support device in an aspect of this invention. The manufacturing study support device 10 comprises a display device 4 which displays animations, a CPU 1 which generates data for the animations for display and transmits the data to the display device 4, random access memory (hereafter RAM) 2 which stores programs executed by the CPU 1, and a hard disk drive (hereafter HDD) 3 which stores part animation data used in display of animations and environment information which is information relating to objects placed in the task position vicinity. The CPU 1, RAM 2 and HDD 3 are interconnected by a bus or similar to exchange data. The display device 4 is connected by a signal line to the CPU 1, and the CPU 1 supplies the display device 4 with signals. An input device 5 is connected by a signal line to the CPU 1, and signals from the input device 5 are supplied to the CPU 1.

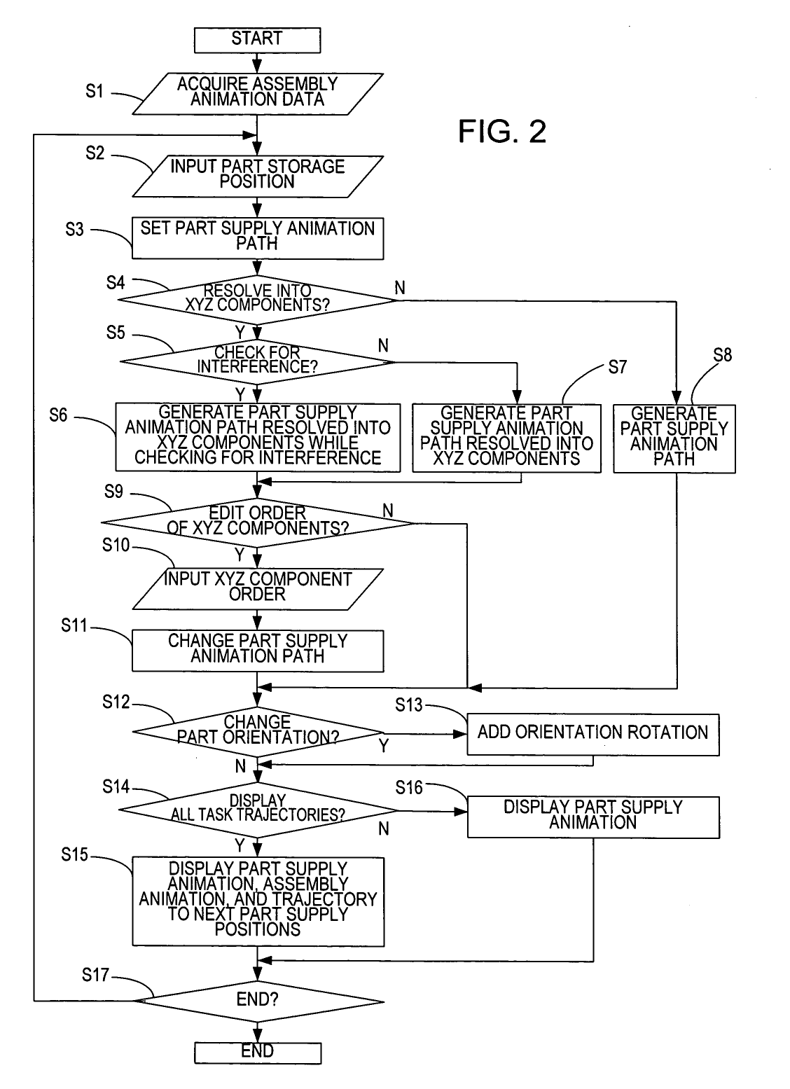

FIG. 2 is a flowchart of part supply animation generation in the manufacturing study support device of an aspect of the invention. When generation of a part supply animation is started, assembly animation data used in assembly and stored in the HDD 3 is acquired (step S1). This assembly animation data is data used in animations showing part assembly tasks, as explained in the technology of the prior art, and is already stored in the HDD 3. From the assembly animation data, assembly starting positions, which are three-dimensional coordinate data for the positions from which part assembly is started, part animation data indicating the three-dimensional shapes of parts, part assembly order, and other information is extracted.

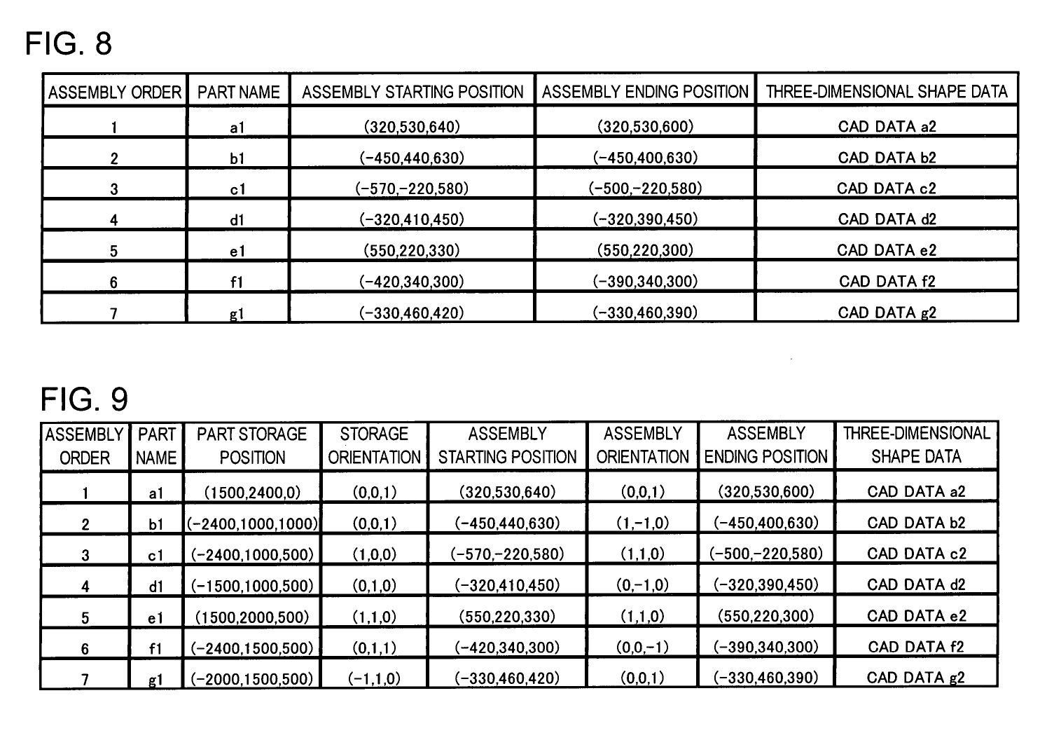

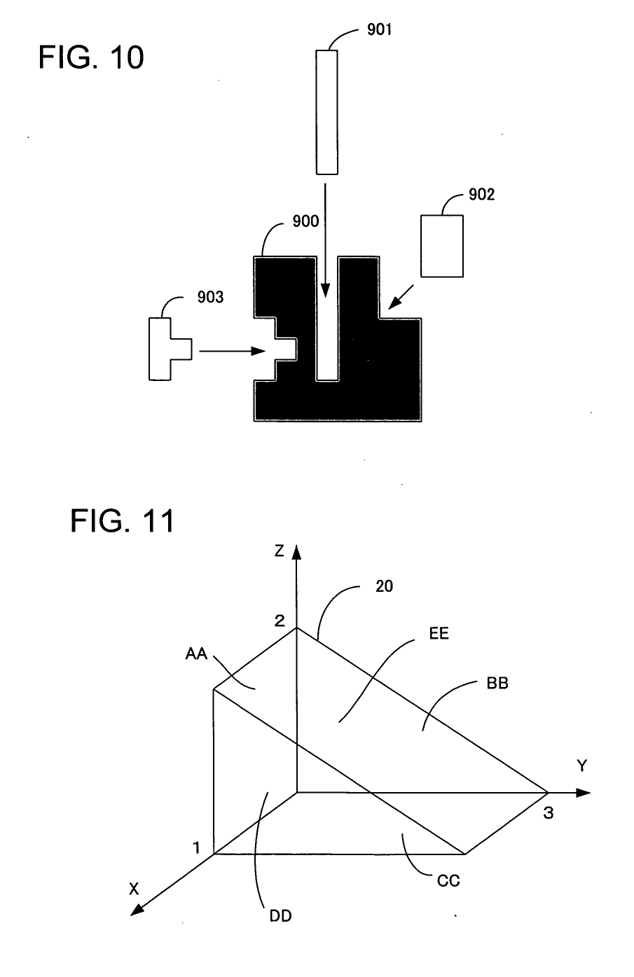

FIG. 8 is an example of the configuration of assembly animation data. Assembly animation data comprises the assembly order, part names, assembly starting positions, assembly ending positions which are three-dimensional coordinate data for positions at which part assembly ends, and three-dimensional shape data for parts. Here, seven parts are mounted on a product main unit, according to the assembly order.

Next, the part storage position at which is stored the part to be used in assembly first among the parts prepared for assembly is input, via the input device 5 (step S2). The part storage position is three-dimensional coordinate data for the position at which the part is stored. At this time, the orientation of the part in the part storage position is also input via the input device 5. The part storage position and the part orientation may be stored in advance in the HDD 3 as a file. As a result of the input of information in step S2, the information held by the manufacturing study support device of this invention is as shown in the data table of FIG. 9.

Here, the CAD data among the three-dimensional shape data comprises, for example, three-dimensional coordinate data representing surfaces and one point on each surface comprising the surfaces of a three-dimensional object, as well as the normal vectors to the surfaces, and distances.

FIG. 11 is an example explaining an example of modeling using CAD data for a three-dimensional object. The trigonal prism 20 comprises a side face AA, rear face BB, lower face CC, side face DD, and upper face EE. The face BB is defined as having vertices at the origin (X,Y,Z)=(0,0,0) and the coordinates (0,0,2) and (0,3,0); the face DD is defined as a face with the same shape, moved a distance 1 in the direction of the normal vector of the face BB; and the faces AA, CC, EE are defined as the movement trajectories (locuses) of the visible lines when moving from face DD to face BB. By this means the various faces are defined, and the object is enclosed between the faces. The three-dimensional shape data in this aspect comprises such information. Returning to FIG. 2, after step S2 the straight line from the input part storage position to the assembly starting position extracted from the assembly animation data is set as the part supply animation path (step S3). Then, a decision is made as to whether to resolve the generated part supply animation path into three-dimensional direction components in the XYZ directions (step S4), and if resolution into XYZ components is performed, whether to perform a check for interference with objects placed in the vicinity (step S5). Here, an interference check is a check as to whether a part supply animation path makes contact with an object placed in the vicinity. Information for the three-dimensional coordinates and three-dimensional shapes of objects placed in the vicinity (hereafter called “environment information”) is either stored in advance in the HDD 3, or is extracted from the assembly animation data.

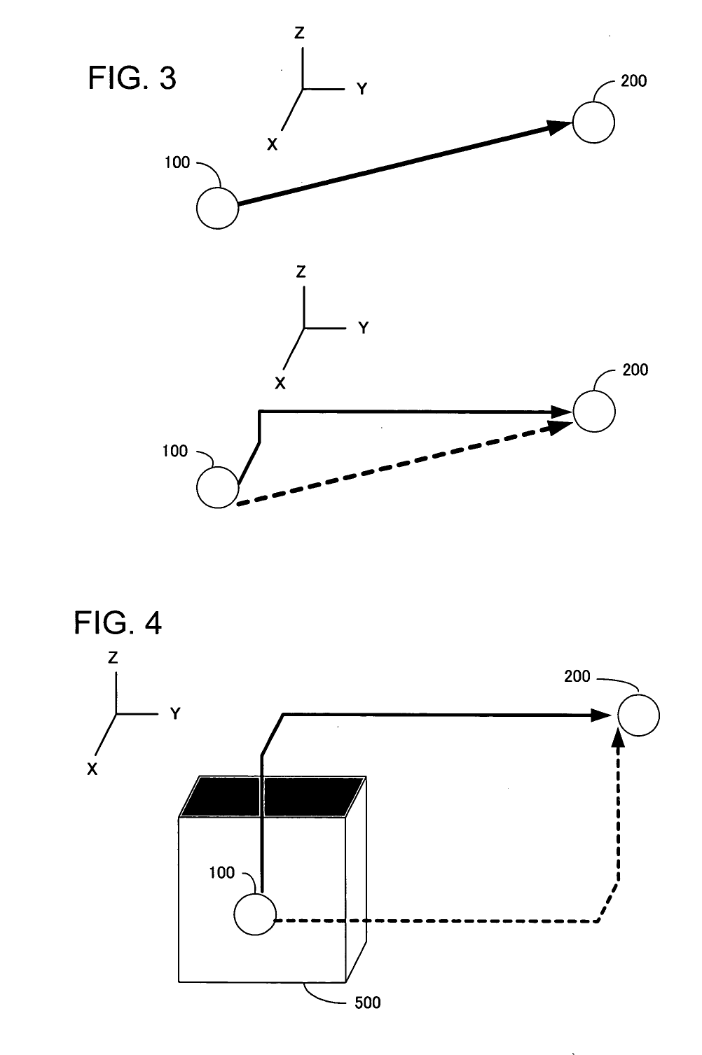

FIG. 3 shows resolution into three-dimensional direction components of a part supply animation path. When resolution is not performed, the straight line from the part storage position 100 to the assembly starting position 200 becomes the part supply animation path. On the other hand, after resolution the part supply animation path, for example, moves in the X-axis direction from the part storage position 100, then moves in the Z-axis direction, and finally moves in the Y-axis direction to reach the assembly starting position 200. By thus combining the three line segments after resolution, a part supply animation path is formed. In the drawing, the part supply animation path is represented by lines; but in an actual animation, an animation image representing the part is realized through movement along the part supply animation path.

Next, interference checks are explained.

FIG. 4 shows a case in which a part supply animation path is resolved into three-dimensional direction components while performing an interference check. In this case, the part storage position 100 is within a box 500 the upper face of which is opened. This box 500 is provided as environment information. In the case of a part supply animation for which movement is in the order Y-axis direction, Z-axis direction, X-axis direction (shown by the broken line), there is contact (interference) between the box 500 and the part. Hence the CPU 1 searches among the part supply animation paths for which movement order is other than this order for a path such that there is no interference with the box 500. In the end, the CPU 1 selects a part supply animation path for which there is no interference (shown by the solid line), with movement in the order Z-axis direction, X-axis direction, Y-axis direction. In the drawing, the part supply animation path is shown as a line, but in an actual animation, an animation image representing the part is realized through movement along the part supply animation path.

Returning to FIG. 2, part supply animation paths are generated according to the selections in step S4 and step S5 (steps S6, S7, S8). In step S8, a part supply animation path is generated with the part storage position 100 as the starting point and the assembly starting position 200 as the ending point. In step S7, a part supply animation path is generated by resolving the straight line with the part storage position 100 as the starting point and the assembly starting position 200 as the ending point into the XYZ three-dimensional direction components. And in step S6, a part supply animation path is generated with the three-dimensional direction components selected such that there is no contact with objects placed in the vicinity.

After generating the part supply animation path, a decision is made as to whether to change the order of the XYZ three-dimensional direction components (step S9). When changing the order of the direction components, the order is input via the input device 5 (step S10), and based on this the part supply animation path is changed (step S11).

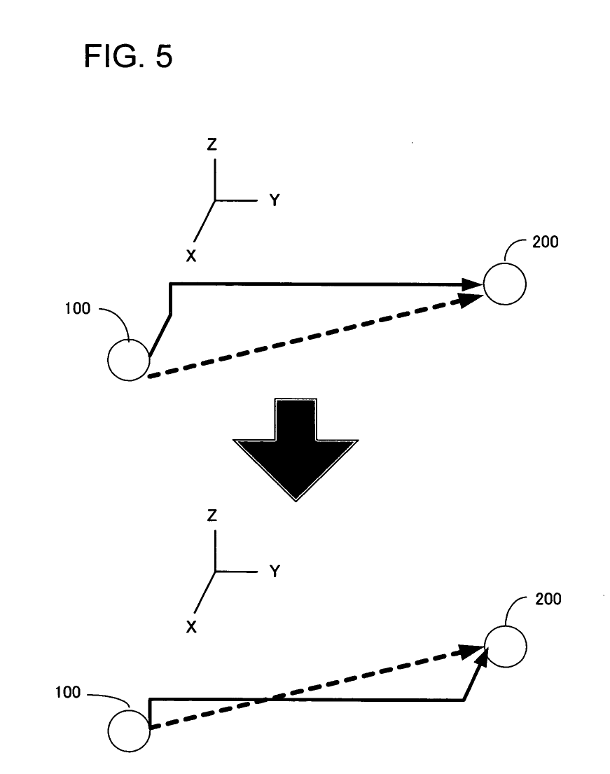

FIG. 5 shows changes in the order of the three-dimensional direction components of a part supply animation path. In a case in which the part supply animation path is resolved into three-dimensional direction components, when an interference check is not performed there are no limits placed on the order of the resolved directions. Even when interference checks are performed, there are cases in which the order of the resolved directions may be selected arbitrarily. Normally resolution is performed in an order determined in advance in the initial settings, but the order can be changed according to the preferences of the user. In FIG. 5, the initial order of the X-axis direction, Z-axis direction, Y-axis direction has been changed to the Z-axis direction, Y-axis direction, X-axis direction. In the drawing, the part supply animation path is represented by a line, but in an actual animation, an animation image representing the part is realized through movement along the part supply animation path.

Returning to FIG. 2, after step S11 the part orientation in the part storage position 100 is compared with the part orientation in the assembly starting position 200 (step S12). The part orientation in the part storage position 100 is input in step S2, and the part orientation in the assembly starting position 200 is extracted from the assembly animation data. When these two orientations are different, rotation of the animation representing the part is added midway in the part supply animation path (step S13).

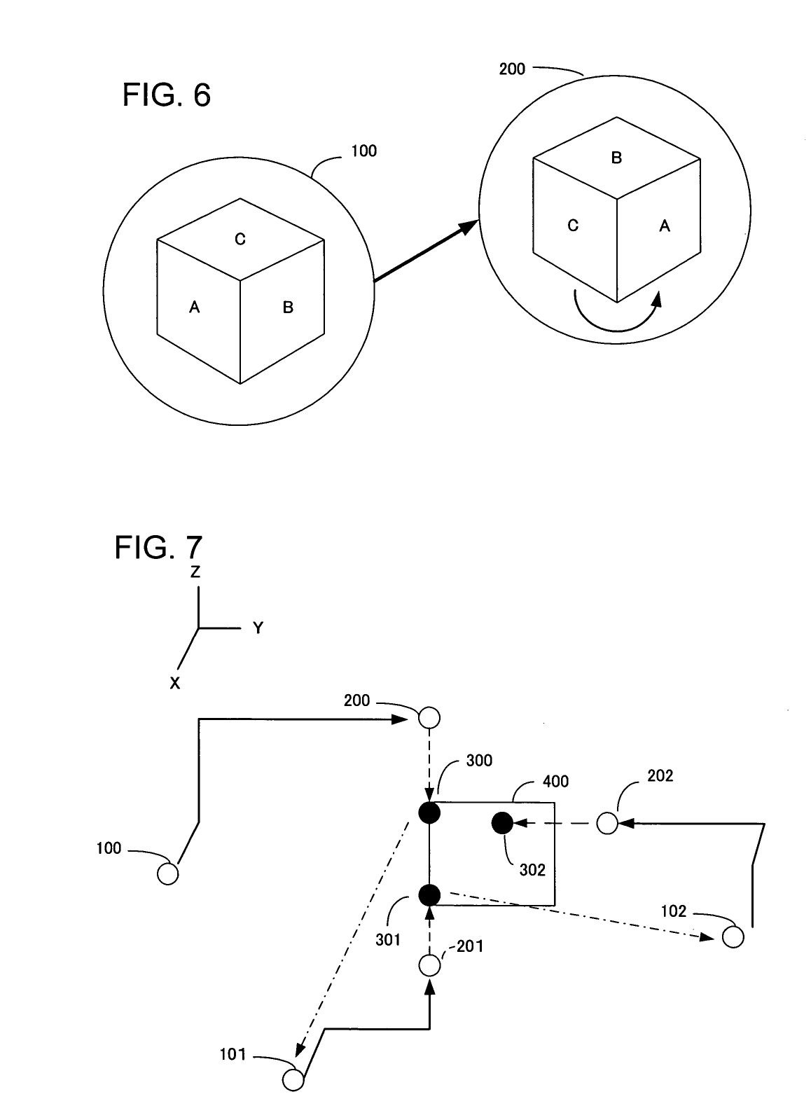

FIG. 6 shows rotation of the orientation of a part. The part in the part storage position 100 is stored with the C face on top, the A face to the left, and the B face to the right. But in the assembly task, the part must be placed with orientation such that the B face is on top, the C face is to the left, and the A face is to the right. Hence midway in the part supply animation path an animation to rotate the part orientation and change the part orientation is inserted.

After step S12, a decision is made as to whether to display only the part supply animation, or to display the part supply animation, assembly animation, and the trajectory up to the next-part supply position (step S14). When displaying only the part supply animation, the animation of movement of the part along the part supply animation path is displayed via the display device 4 (step S16). At this time, the part animation, generated from three-dimensional CAD data extracted from the assembly animation data, is displayed so as to move along the part supply animation path. At the time the display is started, the origin of coordinates of the part three-dimensional CAD data coincides with the three-dimensional coordinates of the part storage position 100, and at the time the display ends, the origin of coordinates of the part three-dimensional CAD data coincides with the three-dimensional coordinates of the assembly starting position 200.

When displaying the part supply animation, assembly animation, and trajectory to the next-part supply position, first, via the display device 4, animation of part movement along the part supply animation path is displayed. At this time, the part animation, generated based on three-dimensional CAD data extracted from the assembly animation data, is displayed so as to move along the part supply animation path. At the time the display starts, the origin of coordinates of the part three-dimensional CAD data coincides with the three-dimensional coordinates of the part storage position 100, and at the time display ends, the origin of coordinates of the part three-dimensional CAD data coincides with the three-dimensional coordinates of the assembly starting position 200. Next, based on the assembly animation data acquired in step S1, an assembly animation is displayed showing the assembly of the part. Finally, the trajectory is shown from the assembly completion position of the part to the part storage position of the next stored part to be used in the assembly task (step S15). When there exists no next stored part to be used in assembly, the trajectory from the assembly completion position to the part storage position 100 is not displayed.

When display of the animation ends, a check is performed to determine whether there exists a next part for an assembly task (step S17), and if such a part exists processing returns to step S2, and similar processing is performed for the part to be used in the next assembly task. If there exists no next part for an assembly task, processing ends.

FIG. 7 is an example of animation for a case in which the part supply animation, assembly animation, and trajectory to the next-part supply position are displayed. Here, a task is explained in which three parts are mounted on a product main unit 400. A part placed in a part storage position 100 reaches the assembly starting position 200 along the part supply animation path. Next, based on the assembly animation data acquired in step S1, the assembly animation up to the assembling ending position 300 is displayed. And, a straight line is displayed from the assembly ending position 300 to the next-part storage position 101. The next part, placed in the part storage position 101, then arrives at the assembly starting position 201 along a part supply animation path. Then, based on assembly animation data, an assembly animation up to the assembly ending position 301 is displayed. A straight line is then displayed from the assembly ending position 301 to the next-part storage position 102. The next part, placed in the part storage position 102, arrives at the assembly starting position 202 along a part supply animation path. Next, based on the assembly animation data, the assembly animation up to the assembly ending position 302 is displayed. Because there exists no next part, the animation display then ends.

In this way, by displaying animations of the supply of parts from part storage positions to assembly starting positions, a manufacturing study support device of an aspect of this invention can support studies of the optimization of part storage positions and assembly starting positions. Personnel in charge of improving the efficiency of assembly tasks can easily study the efficiency of part storage positions and assembly starting positions through animation displays by the manufacturing study support device of an aspect of this invention.

What is claimed is:

1. A manufacturing study support device, which displays the placement of a plurality of parts in a virtual space, displays assembly tasks by causing the movement of representations of said plurality of parts, and supports studies of the efficiency of assembly tasks, comprising:
a computation portion;
a display portion which displays animations; and
a storage portion which stores part animation data comprising the three-dimensional shapes of parts, part storage positions which are three-dimensional coordinate data of positions at which said parts are stored, and assembly starting positions which are three-dimensional coordinate data of positions at which assembly tasks are started using said parts, wherein
said computation portion determines part supply animation paths taking said part storage positions as starting points and said assembly starting positions as ending points, and based on said part animation data and said part supply animation paths, causes movements of said parts to be displayed by said display portion.

2. The manufacturing study support device according to claim 1, wherein said part supply animation path is resolved into a first direction, a second direction orthogonal to said first direction, and a third direction orthogonal to said first and second directions.

3. The manufacturing study support device according to claim 2, wherein the order of display of said three directions of said resolved part supply animation path can be edited.

4. The manufacturing study support device according to claim 1, wherein said storage portion further stores part storage vectors, which are three-dimensional direction vectors indicating the orientations of said parts in said part storage positions, and part assembly vectors, which are three-dimensional direction vectors indicating the orientations of said parts in said assembly starting positions, and
said computation portion generates, and causes said display portion to display, animations showing the orientation rotation to said part supply animation path based on said part assembly vectors, from said part animation data based on said part storage vectors.

5. The manufacturing study support device according to claim 3, wherein said storage portion further stores environment information, comprising three-dimensional coordinate data and three-dimensional shape data for objects existing at positions which may be in said part supply animation paths, and
based on said environment information, said computation portion generates said part supply animation paths which do not interfere with said objects.

6. The manufacturing study support device according to claim 1, wherein said storage portion further stores assembly ending positions, which are three-dimensional coordinate data of positions at which assembly tasks using said parts end, and
said computation portion further causes said display portion to display part assembly paths from said assembly starting positions to said assembly ending positions and next-part movement paths from said assembly ending positions to said part storage positions of parts used in next assembly.

7. A manufacturing study support program, which displays the placement of a plurality of parts in a virtual space, displays assembly tasks by causing the movement of representations of said plurality of parts, and supports studies of the efficiency of assembly tasks, the program causing a computer to execute:
an information acquisition process of acquiring part storage positions, which are three-dimensional coordinate data of the positions in which parts are stored, and assembly starting positions, which are three-dimensional coordinate data of the positions from which assembly tasks using said parts are started;
a path calculation process of calculating part supply animation paths, taking said part storage positions as starting points and said assembly starting positions as ending points, and
a display process of displaying the movement of said parts, based on part animation data comprising the three-dimensional shapes of said parts and on said part supply animation paths.

8. The manufacturing study support program according to claim 7, wherein said part supply animation path is resolved into a first direction, a second direction orthogonal to said first direction, and a third direction orthogonal to said first and second directions.

9. The manufacturing study support program according to claim 8, wherein the order of display of said three directions of said resolved part supply animation path can be edited.

10. The manufacturing study support program according to claim 7, wherein said information acquisition process further acquires part storage vectors, which are three-dimensional direction vectors indicating the orientations of said parts in said part storage positions, and part assembly vectors, which are three-dimensional direction vectors indicating the orientations of said parts in said assembly starting positions, and
said display process further displays animations showing the orientation rotation to said part supply animation path based on said part assembly vectors, from said part animation data based on said part storage vectors.

11. The manufacturing study support program according to claim 9, wherein, based on environment information comprising three-dimensional coordinate data and three-dimensional shape data for objects existing at positions which may be in said part supply animation paths, said path calculation process further calculates said part supply animation paths which do not interfere with said objects.

12. The manufacturing study support program according to claim 7, wherein said information acquisition process further acquires assembly ending positions, which are three-dimensional coordinate data of positions at which assembly tasks using said parts end,
said path calculation process further calculates part assembly paths from said assembly starting positions to said assembly ending positions and next-part movement paths from said assembly ending positions to said part storage positions of parts used in next assembly, and
said display process further displays said part assembly paths and said next-part movement paths.

13. A manufacturing study support method for displaying the placement of a plurality of parts in a virtual space, displaying assembly tasks by causing the movement of representations of said plurality of parts, and supporting studies of the efficiency of assembly tasks, comprising:
an information acquisition process of acquiring part storage positions, which are three-dimensional coordinate data of the positions in which parts are stored, and assembly starting positions, which are three-dimensional coordinate data of the positions from which assembly tasks using said parts are started;
a path calculation process of calculating part supply animation paths, taking said part storage positions as starting points and said assembly starting positions as ending points; and,
a display process of displaying the movement of said parts, based on part animation data comprising the three-dimensional shapes of said parts and on said part supply animation paths.

14. The manufacturing study support method according to claim 13, wherein said part supply animation path is resolved into a first direction, a second direction orthogonal to said first direction, and a third direction orthogonal to said first and second directions.

15. The manufacturing study support method according to claim 14, wherein the order of display of said three directions of said resolved part supply animation path can be edited.

16. The manufacturing study support method according to claim 13, wherein said information acquisition process further acquires part storage vectors, which are three-dimensional direction vectors indicating the orientations of said parts in said part storage positions, and part assembly vectors, which are three-dimensional direction vectors indicating the orientations of said parts in said assembly starting positions; and,
said display process further displays animations showing the orientation rotation to said part supply animation path based on said part assembly vectors, from said part animation data based on said part storage vectors.

17. The manufacturing study support method according to claim 15, wherein, based on environment information comprising three-dimensional coordinate data and three-dimensional shape data for objects existing at positions which may be in said part supply animation paths, said path calculation process further calculates said part supply animation paths which do not interfere with said objects.

18. The manufacturing study support method according to claim 13, wherein said information acquisition process further acquires assembly ending positions, which are three-dimensional coordinate data of positions at which assembly tasks using said parts end;
said path calculation process further calculates part assembly paths from said assembly starting positions to said assembly ending positions and next-part movement paths from said assembly ending positions to said part storage positions of parts used in next assembly, and,
said display process further displays said part assembly paths and said next-part movement paths.
